(19) United States
(12) Patent Application Publication
(10) Pub. No.: US 2013/0254016 A1
(43) Pub. Date: Sep. 26, 2013

(54) DATA PROCESSING SYSTEM, SERVER, AND COMPUTER-READABLE RECORDING MEDIUM RECORDING PROGRAM FOR DATA PROCESSING SYSTEM

(71) Applicants: Yoshiaki Yuyama, Tokyo (JP); Tatsuzi Ichikawa, Saitama (JP); Junichi Takei, Tokyo (JP); Kanoo Nakayama, Kanagawa (JP)

(72) Inventors: Yoshiaki Yuyama, Tokyo (JP); Tatsuzi Ichikawa, Saitama (JP); Junichi Takei, Tokyo (JP); Kanoo Nakayama, Kanagawa (JP)

(73) Assignees: CASIO INFORMATION SYSTEMS CO., LTD, Tokyo (JP); CASIO COMPUTER CO., LTD., Tokyo (JP)

(21) Appl. No.: 13/846,006

(22) Filed: Mar. 18, 2013

(30) Foreign Application Priority Data
Mar. 21, 2012 (JP) 2012-064057

(51) Int. Cl. G06Q 30/02

(52) U.S. Cl. CPC G06Q 30/0244
USPC 705/14.43

(57) ABSTRACT

Disclosed is a data processing system including a plurality of terminals and a server connected to the terminals via a communication network. Each of the terminals includes a display unit, a layout modifier which modifies the layout data of the POP advertisement in response to a user operation, and an improvement-report-data transmitter which transmits the improvement report data to the server. The server includes an improvement analyzer which stores the linked analytical result and the improvement report data in a storage unit, and an analysis transmitter which transmits at least the POP advertisement of before and after the modification and the analytical result of the modification among the improvement report data stored in the storage unit in response to a request from any one of the terminals.

### BACKGROUND OF THE INVENTION

1. Field of the Invention

The present invention relates to a data processing system, a server, and a computer-readable recording medium recording a program for data processing system.

2. Description of Related Art

Nowadays, point-of-purchase (POP) advertising is used for sales promotion at major retailers and major supermarkets. Recently, computer systems have been proposed for preparing POP advertisements (layout design), such as that disclosed in Japan Patent No. 3807805.

There are three typical operation patterns for preparation of a POP advertisement:

(1) Preparation of a layout design and layout data (POP data) for a POP advertisement at a head office and transmission of the POP data to a shop together with the instruction for the display location of the POP advertisement;

(2) Preparation of POP data with a personal computer (PC) at the office of a shop; or

(3) Preparation of a POP advertisement manually at the office of a shop.

Preparation of POP advertisements at the head office or a shop office leads to the overlooking of details that can only be noticed at the selling floor.

For example, the head office may give an instruction to “display a B6-size POP advertisement behind the tomatoes”; however, selling floors have problems such as “indistinctive B6-size POP advertisement” and “improper position of the POP advertisement due to indistinctive arrangement” on occasion. Such problems were overlooked because the head office and/or shop office do not have enough information on the conditions of the selling floors. As a result, POP advertising often does not contribute to an increase in sales.

A solution to the problems described above requires suggestions for improvement by persons in charge of the selling floor. Unless the persons in charge of the selling floor are allowed to actively make improvements to increase sales, the persons in charge of the selling floor will be nothing more than salesclerks, being restrained from making suggestions for improvements to increase sales.

### SUMMARY OF THE INVENTION

An object of the present invention is to provide a system that encourages persons in charge of a selling floor to actively improve the selling floor through an improvement in POP advertising and share the actual improvement leading to sales increase.

According to an aspect of the present invention, a data processing system includes a plurality of terminals and a server connected to the terminals via a communication network, and each of the terminals includes a display unit which displays a POP advertisement based on predetermined layout data of the POP advertisement, a layout modifier which modifies the layout data of the POP advertisement displayed on the display unit in response to a user operation, and an improvement-report-data transmitter which acquires the layout data of the POP advertisement of before and after a modification by the layout modifier, generates improvement report data by linking the acquired layout data with information on a target product in the POP advertisement and information associated with the modification of the layout data of the POP advertisement, and transmits the improvement report data to the server, and the server includes an improvement analyzer which analyzes a sales effect of the target product on the selling floor of the shop in which the modification was carried out on the layout data of the POP advertisement reported in the improvement report data from any of the terminals, links the analytical result with the improvement report data, and stores the linked analytical result and the improvement report data in a storage unit, and an analysis transmitter which transmits at least the POP advertisement of before and after the modification and the analytical result of the modification among the improvement report data stored in the storage unit in response to a request from any one of the terminals.

According to another aspect of the present invention, a server connected to a terminal via a communication network includes a receiver which receives improvement report data including a modification performed on predetermined layout data of a POP advertisement transmitted from the terminal, information on a target product in the POP advertisement and information associated with the modification of the layout data of the POP advertisement, and an analyzer which analyzes a sales effect on the target product on the selling floor of the shop in which the modification was carried out on the layout data of the POP advertisement reported in the improvement report data from any of the terminals, links the analytical result with the improvement report data, and stores the linked analytical result and the improvement report data in a storage unit, and a transmitter which transmits at least the POP advertisement of before and after the modification and the analytical result of the modification among the improvement report data stored in the storage unit in response to a request from the terminal.

According to another aspect of the present invention, a non-transitory computer-readable medium which stores a program for instructing a computer to perform a procedure includes receiving improvement report data containing a modification performed on predetermined layout data of a POP advertisement, information on a target product in the POP advertisement and information associated with the modification of the layout data of the POP advertisement from a terminal connected via a communication network, analyzing a sales effect of the target product on the selling floor of the shop in which the modification was carried out on the layout data of the POP advertisement reported in the improvement report data from the terminals, linking the analytical result with the improvement report data, and storing the linked analytical result and the improvement report data in a storage unit, and transmitting at least the POP advertisement of before and after the modification and the analytical result of the modification among the improvement report data stored in the storage unit in response to a request from the terminal.

The present invention provides a system that encourages a person in charge of a selling floor to actively improve the selling floor through an improvement in POP advertising and share the actual improvement leading to sales increase.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 illustrates the overall configuration of a selling-floor improvement system according to an embodiment of the present invention;

FIG. 2 is a block diagram of the functional configuration of a head-office server in FIG. 1;

FIG. 3 is a block diagram of the functional configuration of a selling-floor terminal in FIG. 1;

FIG. 4 is a flowchart illustrating a POP improvement process carried out by the CPU in FIG. 3;

FIG. 5 illustrates an example POP menu displayed on the display unit in FIG. 3;

FIG. 6 illustrates an example template list displayed on the display unit in FIG. 3;

FIG. 7 illustrates an example layout editing menu displayed on the display unit in FIG. 3;

FIG. 8 illustrates an example entry table;

FIG. 9 illustrates an example improvement report sheet;

FIG. 10 is a flow chart illustrating an improvement analysis process carried out by the CPU in FIG. 2;

FIG. 11 illustrates an example analytical result sheet; and

FIG. 12 is a flow chart illustrating a success-case browsing process carried out by the selling-floor terminals and the head-office server.

### DESCRIPTION OF THE PREFERRED EMBODIMENTS

Embodiments of the present invention will now be described in detail with reference to the accompanying drawings.

The present invention should not be limited to the preferred embodiments and drawings described below.

### [Configuration of Selling-Floor Improvement System 100]

The configuration of this embodiment will now be described.

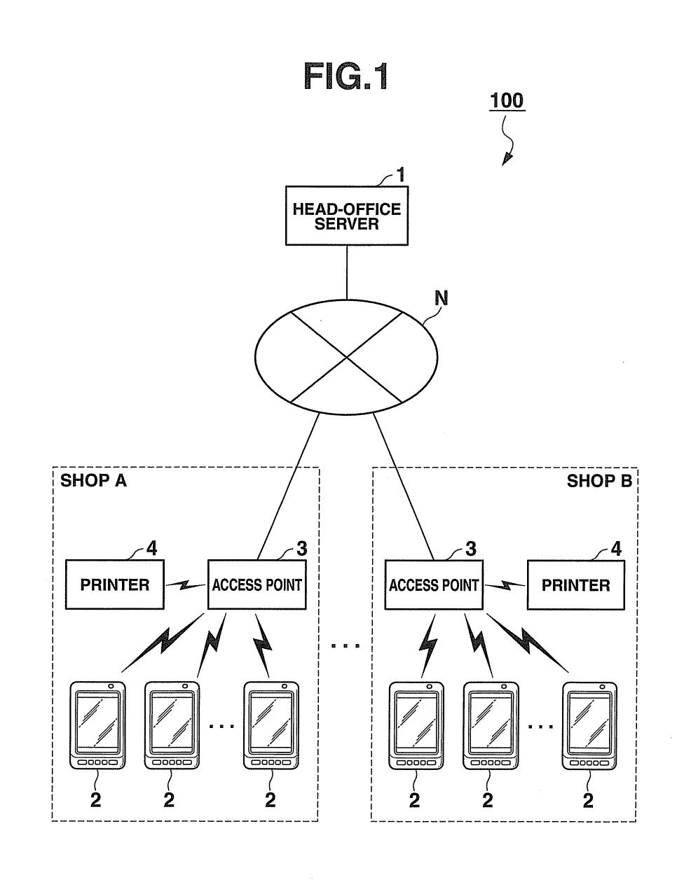

FIG. 1 illustrates the overall configuration of the selling-floor improvement system 100 according to this embodiment.

When persons in charge of selling floor of shops (for example, shops A and B) of a chain store organization developing multiple branches, such as a supermarket, major retailer, and a specialty shop, improve POP advertisements (hereinafter simply referred to as POP) as an improvement in the selling floors and register (enter) the content of the improvement in a head-office server 1, the selling-floor improvement system 100, which is a data processing system, analyzes the effect of the improvement on the POP on sales increase, provides a feedback to the persons in charge of the selling floors about the analytical results, and allows browsing of the effect of the POP improvement on sales increase from the shops. “POP improvement” refers to an improvement in existing POP data and, specifically, refers to a modification of the existing POP data. In this embodiment, the existing POP data is assigned by the head office.

As illustrated in FIG. 1, the selling-floor improvement system 100 includes a head-office server 1 and selling-floor terminals 2 that communicate with the server 1 via a communication network N. The head-office server 1 is installed in a head office that comprehensively controls multiple shops, while the selling-floor terminals 2 are disposed in the shops including shops A and B. The communication network N is composed of, for example, a local area network (LAN), a wide area network (WAN), and/or the Internet. Each selling-floor terminal 2 connects to the communication network N via an access point 3 installed in the corresponding shop and transmits/receives data to/from the head-office server 1. Each shop is equipped with a printer 4 for printing POPs. The selling-floor terminal 2 transmits the image data of a POP to the printer 4 via the access point 3 to print out the POP with the printer 4. The number of shops and the number of selling-floor terminals 2 for each shop are not limited to those in the drawings.

### [Configuration of Head-Office Server 1]

The head-office server 1 functions as a point-of-sale (POS) system for collection of sales data from every shop (for example, shops A and B) and analysis of the collected data. In this embodiment, the head-office server 1 analyzes the sales increase by improvement of the selling floors through POP improvement entered via the selling-floor terminals 2 (persons in charge of the selling floors) of every shop, feeds back the analytical results to the persons in charge, and allows browsing of the analytical results from every shop.

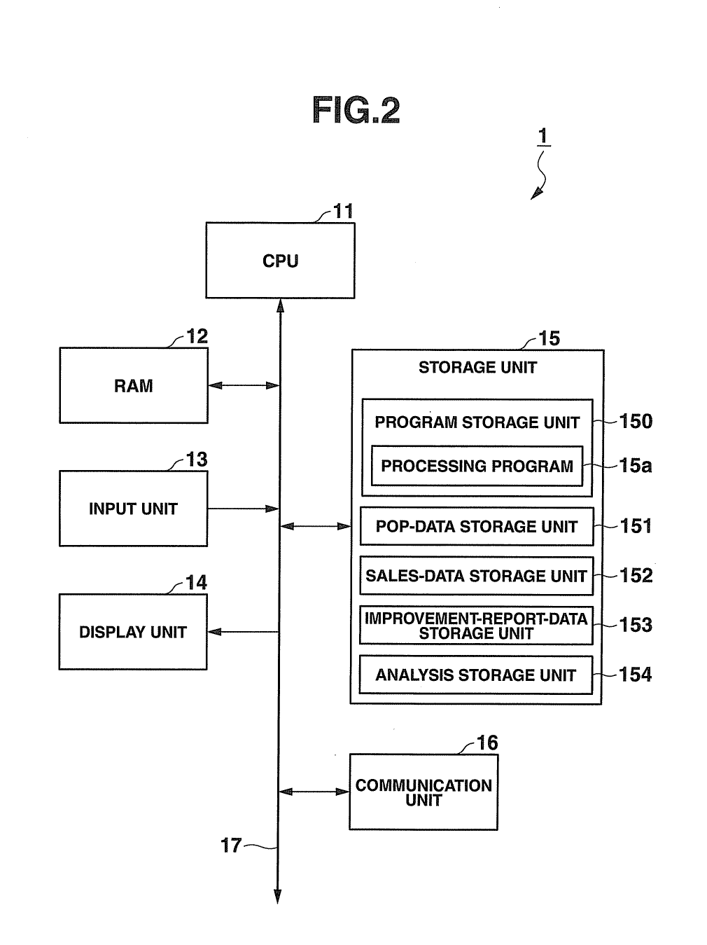

FIG. 2 is a block diagram of the functional configuration of the head-office server 1.

As illustrated in FIG. 2, the head-office server 1 includes a central processing unit (CPU) 11, a random access memory (RAM) 12, an input unit 13, a display unit 14, a storage unit 15, and a communication unit 16, which are mutually connected via a bus 17.

The CPU 11 reads a system program stored in the storage unit 15, loads it into a work area in the RAM 12, and controls the units in accordance with the system program.

The CPU 11 reads a processing program 15a stored in the storage unit 15, loads it into a work area, and carries out various processes, such as improvement analysis and success-case browsing carried out at the head-office server 1, which will be described below, to function as an improvement analyzer, an analytical-result transmitter, and a layout-data generator.

The RAM 12 is a volatile memory. The RAM 12 has a work area for storing various programs and data associated with these programs.

The input unit 13 includes a keyboard that has cursor keys, character and number keys, and various function keys. Information is sent to the CPU 11 in response to the operation of the keys by an operator. The input unit 13 includes a pointing device, such as a mouse, that receives a location as operation information and sends this information to the CPU 11.

The display unit 14 is, for example, a liquid crystal display (LCD) or a cathode ray tube (CRT) and displays a screen corresponding to a display control signal from the CPU 11.

The storage unit 15 is, for example, a hard disk drive (HDD) including a magnetic recording medium or a non-volatile semiconductor memory. As illustrated in FIG. 2, the storage unit 15 includes a program storage unit 150, a POP-data storage unit 151, a sales-data storage unit 152, an improvement-report-data storage unit 153, and an analytical-result storage unit 154.

The program storage unit 150 stores the system program and the processing program 15a carried out at the CPU 11 and data required for carrying out these programs. The processing program 15a includes a POP preparation program and programs for carrying out various processes at the head-office server 1, including improvement analysis and success-case browsing, which will be described below. The POP preparation program is application software shared with the selling-floor terminals 2. This application software contains data required for carrying out the POP preparation program, including material data (such as templates, example sentences, and fonts) for the components of the POP layout.

Such programs are stored in the program storage unit 150 as computer-readable program codes. The CPU 11 operates in accordance with the program codes.

The POP-data storage unit 151 stores POP data used to instruct (or has been used to instruct) the preparation of POPs from the head office to the shops. POP data is data on a POP layout and contains information on components of a POP layout, such as the type of templates, the sheet size, the items to be included, the arrangement of the items, the content of the items, the format (font type, font size, font color, etc.) of the items, and example sentences. The POP data contains header information of product information and other information on the target product.

The POP-data storage unit 151 stores POP management information including the file name of the POP data stored in the POP-data storage unit 151, the shop information on the shop instructed to prepare a POP (shop code, shop name, selling floor name, etc.), the product information (product code, product name, the category of the product, etc.), the scheduled transmission date, and the actual transmission date.

The sales-data storage unit 152 stores sales data (actual sales) of different products sent from the shops.

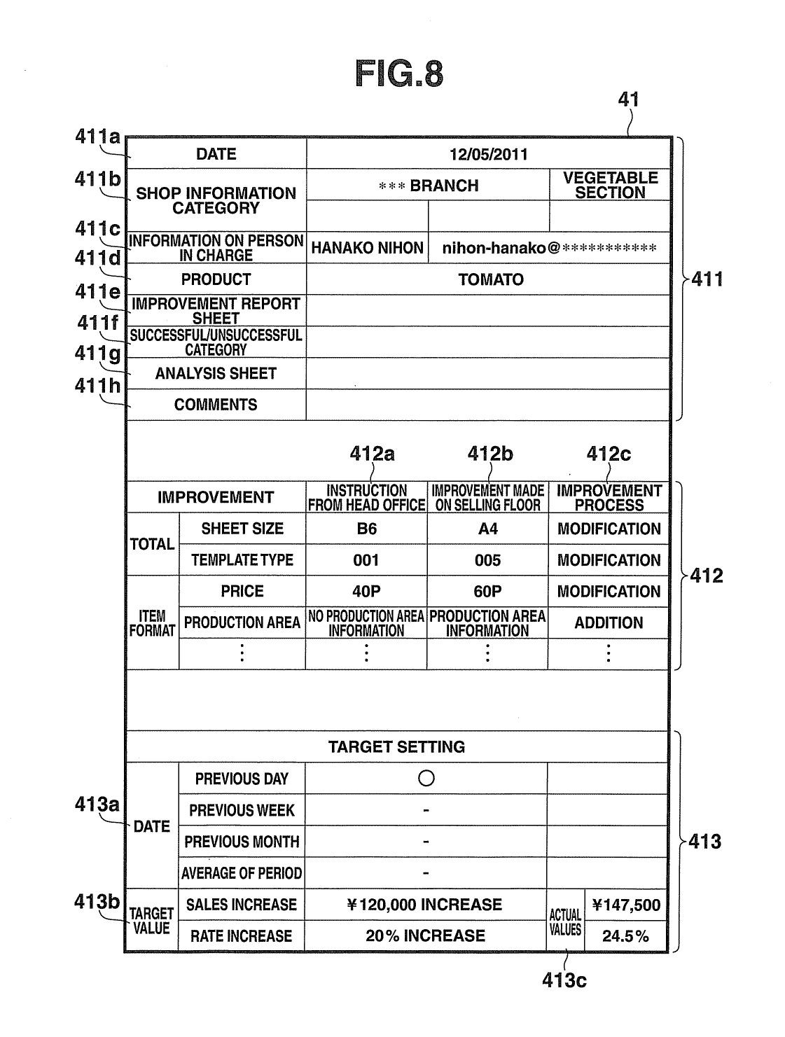

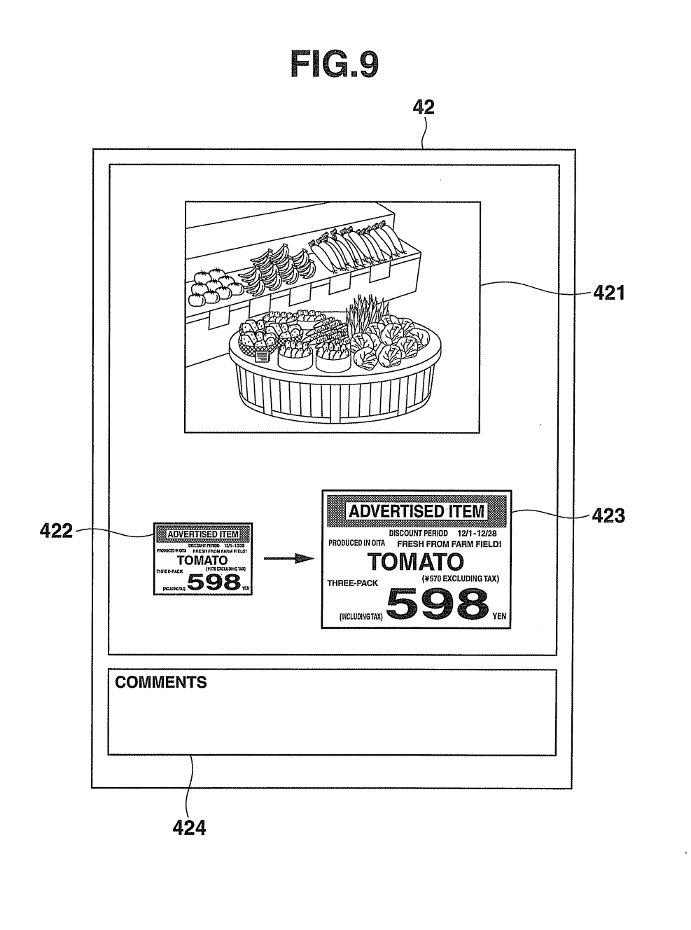

The improvement-report-data storage unit 153 stores improvement report data sent from the selling-floor terminals 2 of the shops. Improvement report data is a report on the improvements in the POP to be sent to the head office and, in this embodiment, contains an entry table 41 (see FIG. 8) and an improvement report sheet 42 (see FIG. 9), which will be described below.

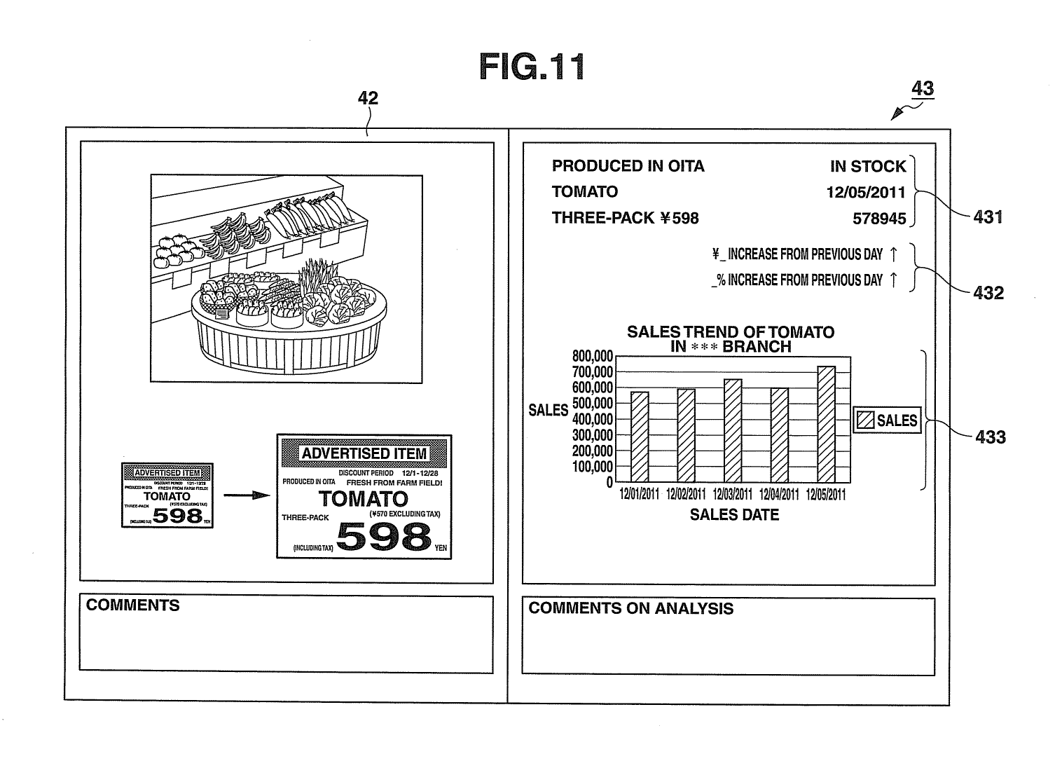

The analytical-result storage unit 154 contains folders for different categories in which the entry table 41 (see FIG. 8) and an analytical result sheet 43 (see FIG. 11) described below are linked for each category.

The storage unit 15 stores information on the selling-floor terminals 2 used indifferent selling floors in the shops. For example, the storage unit 15 stores the terminal identification information, shop name, selling floor name, IP address, and other relevant information of the selling-floor terminals 2 which are linked to each other.

The communication unit 16 includes a modem, a terminal adapter (TA), a router, a network card, and other components. The communication unit 16 communicates with external devices, such as the selling-floor terminals 2 connected to the communication network N, to transmit/receive data.

### [Configuration of Selling-Floor Terminal 2]

Each selling-floor terminal 2 is a portable terminal carried by a person in charge of a selling floor in a shop. The selling-floor terminal 2 is, for example, a tablet PC, a notebook PC, or a smart phone. A tablet PC is preferred due to convenience. In this embodiment, upon modification of the POP data from the head office by a person in charge of a selling floor, the selling-floor terminal 2 acquires the content of the improvement and transmits improvement report data based on the entry operation by the person in charge of a selling floor to the head-office server 1.

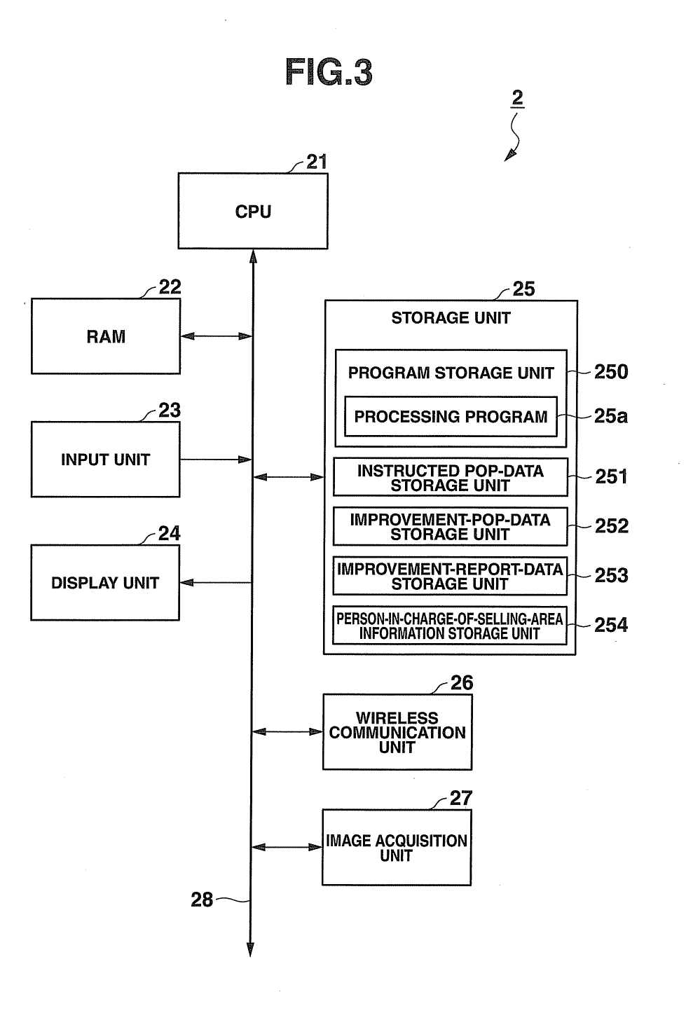

FIG. 3 is a block diagram of the functional configuration of a selling floor terminal 2.

As illustrated in FIG. 3, the selling-floor terminal 2 includes a CPU 21, a RAM 22, an input unit 23, a display unit 24, a storage unit 25, a wireless communication unit 26, and an image acquisition unit 27, which are mutually connected via a bus 28.

The CPU 21 reads a system program stored in the storage unit 25, loads it into a work area in the RAM 22, and controls the units in accordance with the system program.

The CPU 21 reads a processing program 25a stored in the storage unit 25, loads it into a work area, and carries out various processes carried out at the selling-floor terminals 2, such as POP improvement and success-case browsing, which are described below, to function as a layout modifier, an improvement-report-data transmitter, and a layout-data generator.

The RAM 22 is a volatile memory. The RAM 22 has a work area for storing various programs and data associated with the programs.

The input unit 23 includes a pressure-sensitive (resistive) touch panel composed of transparent electrodes arranged in a grid and covering the upper surface of the LDC of the display unit 24. The input unit 23 detects the XY coordinates of the point where force is applied by a finger, stylus, or another device as a voltage value and sends a position signal corresponding to the detected point to the CPU 21 as an operation signal. The touch panel is not limited to a touch-sensitive type and may otherwise be of an electrostatic type or an optical type.

The display unit 24 is composed of an LCD and other components and displays a menu in accordance with a display control signal from the CPU 21.

The storage unit 25 is, for example, an HDD including a magnetic recording medium or a non-volatile semiconductor memory. As illustrated in FIG. 3, the storage unit 25 includes a program storage unit 250, an instructed POP-data storage unit 251, an improvement-POP-data storage unit 252, an improvement-report-data storage unit 253, and a person-in-charge-of-selling-floor information storage unit 254.

The program storage unit 250 stores the system program and the processing program 25a carried out at the CPU 21 and data required for carrying out these programs. The processing program 25a includes a POP preparation program and programs for carrying out various processes carried out at the selling-floor terminal 2, including POP improvement and success-case browsing, which are described below. The POP preparation program is application software shared with the head-office server 1. This application software contains data required for carrying out the POP preparation program, including material data (such as templates, example sentences, and fonts) for the components of the POP layout.

Such programs are stored in the program storage unit 250 as computer-readable program codes. The CPU 21 operates in accordance with the program codes.

The instructed POP-data storage unit 251 stores POP data for preparation instructed by the head-office server 1.

The improvement-POP-data storage unit 252 stores POP data modified by the person in charge of the selling floor.

The improvement-report-data storage unit 253 stores improvement report data prepared by the corresponding selling-floor terminal 2.

The person-in-charge-of-selling-floor information storage unit 254 stores basic information on the site at which the selling-floor terminal 2 is being used (shop information, such as shop name and selling floor name, and information on the person in charge, such as name and e-mail address of the person in charge).

The wireless communication unit 26 is composed of a wireless interface, such as a wireless antenna and a wireless LAN card. The wireless communication unit 26 wirelessly communicates with the access point 3 of the wireless LAN (such as IEEE802.11a/b/g/n) and accesses an external device, including the head-office server 1 connected to the communication network N via the access point 3 to transmit/receive data.

The image acquisition unit 27 includes an image acquisition element, such as a charge coupled device (CCD) or a complementary metal oxide semiconductor (CMOS). The image acquisition unit 27 forms an optical image of an object on the image acquisition element and sends the image to the CPU 21 as an electric signal.

### [Operation of Selling-floor Improvement System 100]

The operation of the selling-floor improvement system 100 will now be described.

Prerequisites for the processes described below are as follows: The head-office server 1 prepares POP data in cooperation with the CPU 11 and the processing program 15a, in response to the operation of the input unit 13 and stores the POP data in the POP-data storage unit 151. The POP data is then transmitted via the communication unit 16 to a relevant selling-floor terminal 2 at a shop/selling floor that has received instructions for preparation on the basis of the POP management information stored in the POP-data storage unit 151.

At the selling-floor terminal 2, the wireless communication unit 26 receives the POP data of which the preparation has been instructed by the head-office server 1 in cooperation with the CPU 21 and the processing program 25a, and the received POP data is stored in the instructed POP-data storage unit 251.

### POP Improvement

The POP improvement carried out by every selling-floor terminal 2 will now be described.

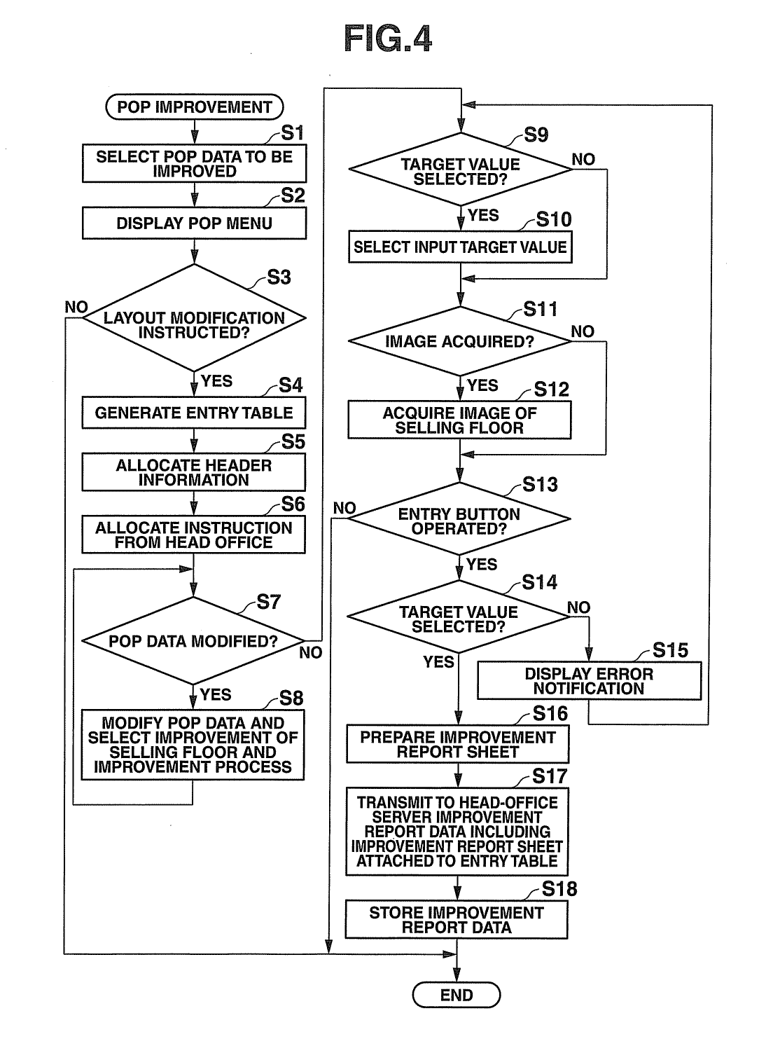

FIG. 4 is a flow chart illustrating the POP improvement process. The POP improvement process is carried out in cooperation with the CPU 21 and the processing program 25a stored in the storage unit 25.

Upon selection of a POP data set to be improved by the input unit 23 among the POP data sets stored in the instructed POP-data storage unit 251 (Step S1), the POP preparation program is launched to prepare a POP image based on the selected POP data, and a POP menu 241 including the POP image is displayed on the display unit 24 (Step S2).

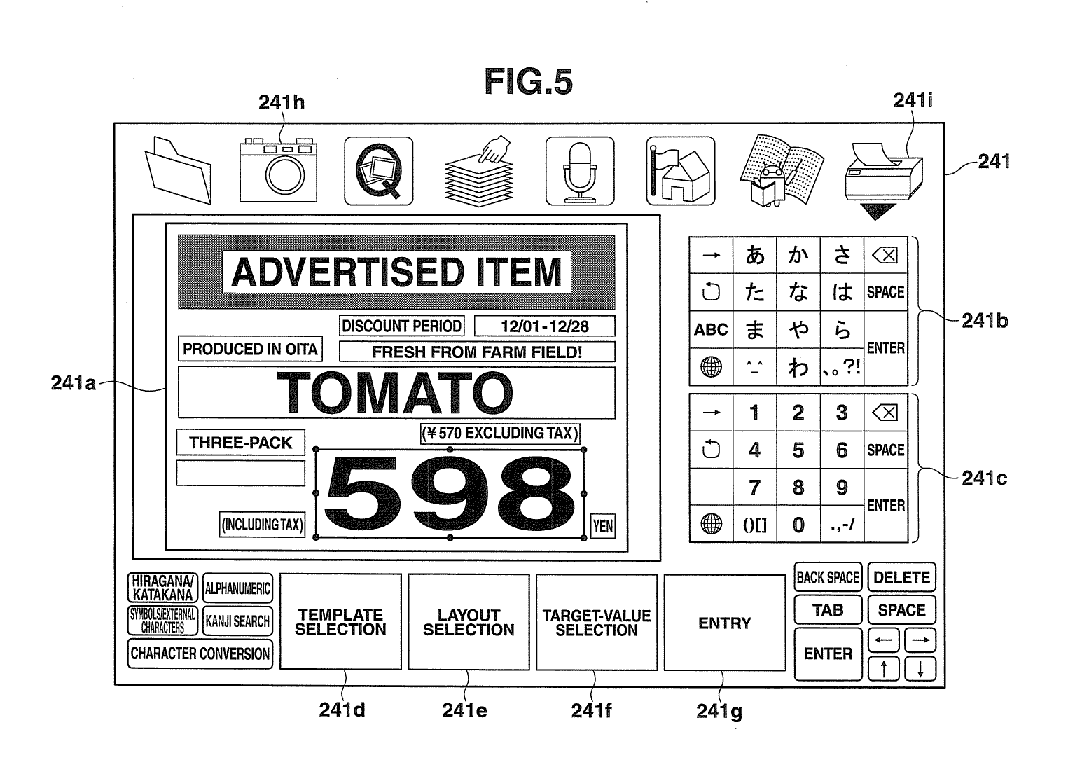

FIG. 5 illustrates an example POP menu 241.

As illustrated in FIG. 5, the POP menu 241 includes a POP display area 241a, a keypad area 241b, a numerical keypad area 241c, a template-selection button 241d, a layout-selection button 241e, a target setting button 241f, an entry button 241g, an image-acquisition button 241h, and an output button 241i.

The POP display area 241a displays a POP image based on the POP data.

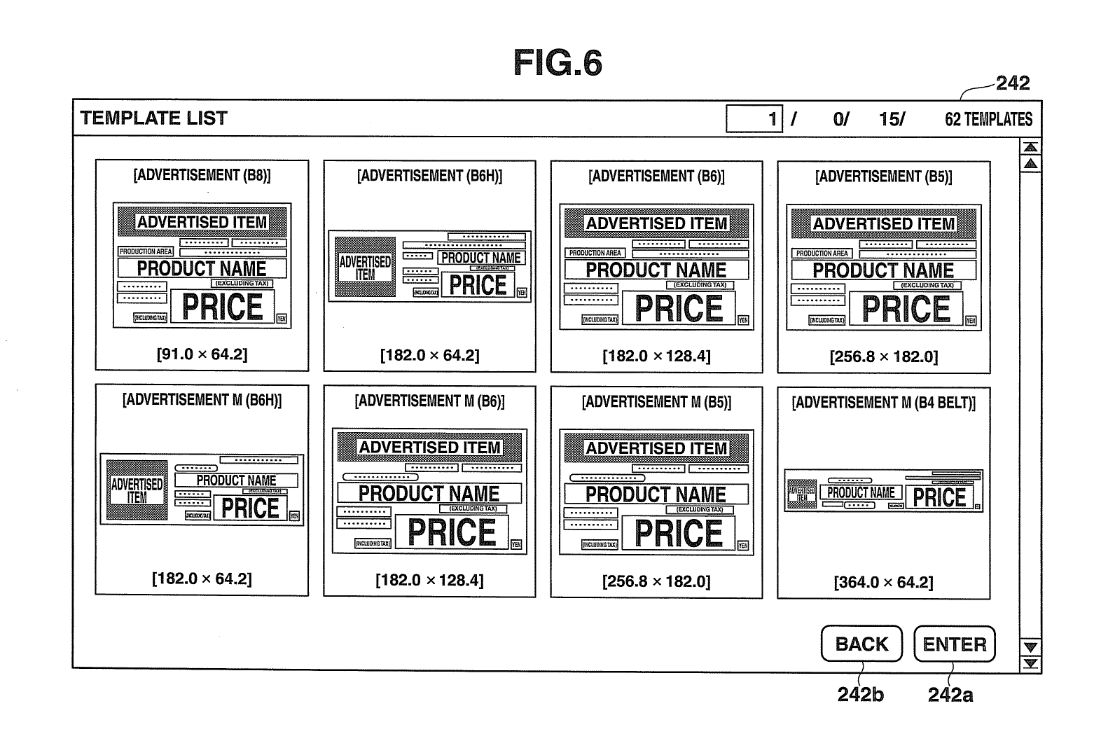

The template-selection button 241d is activated to select another template for the POP data. The activation of the template-selection button 241d through the input unit 23 displays a template list 242, which is illustrated in FIG. 6, on the display unit 24. Upon the selection of a template from the template list 242 through the input unit 23 and the activation of the enter button 242a, another template type is selected for the POP data, and the updated POP data is stored in the improvement-POP-data storage unit 252. The process then returns to the POP menu 241, so that the template of the POP image displayed in the POP display area 241a is updated.

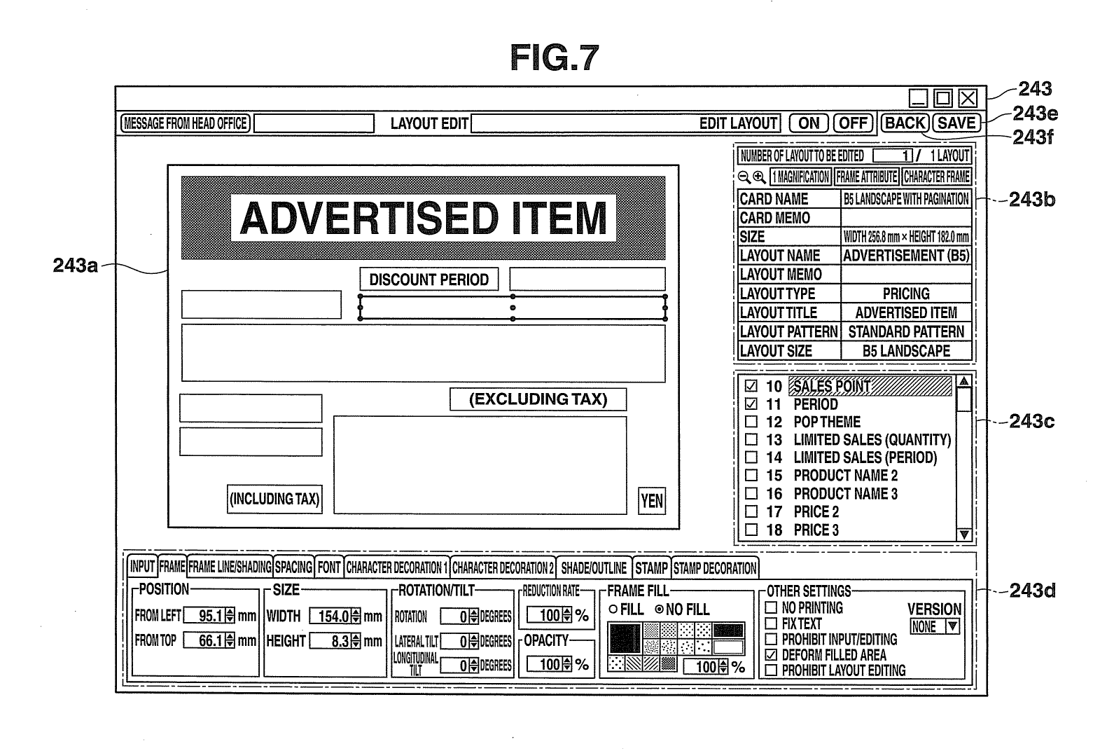

The layout-selection button 241e is activated to precisely modify the layout of the POP data. Upon the activation of the layout-selection button 241e through the input unit 23, a layout editing menu 243, which is illustrated in FIG. 7, appears on the display unit 24.

As illustrated in FIG. 7, the layout editing menu 243 includes an item layout area 243a, a layout-information display area 243b, an item addition area 243c, and an item-format selection area 243d. The item layout area 243a is operated to modify the position and size of the items arranged in the POP and the content of the items. The layout-information display area 243b is a space for displaying the layout information. The item addition area 243c is operated to select additional items. The item-format selection area 243d is operated to change the format of the characters displayed in the items. The POP data is temporarily updated in the RAM 22 in response to the operation of the input unit 23 in these areas. Then, upon activation of the save button 243e, the updated POP data is stored in the improvement-POP-data storage unit 252. Upon the activation of the return button 243f, the display screen returns to the POP menu 241 including the updated POP image appearing in the POP display area 241a.

The target setting button 241f in FIG. 5 is activated to display a menu for setting the target value and the target date of a sale increase to be achieved through the POP improvement.

The entry button 241g is activated to register (enter) the improved content of the POP data to the head-office server 1.

The image-acquisition button 241h is activated to enter an image-acquisition mode.

The output button 241i is activated to output a POP image based on the POP data. Clicking the arrow below the output button 241i with the input unit 23 displays a pull-down output menu. Selection of an item in the output menu with the input unit 23 outputs the POP image in the selected output format. The output menu may include items such as printout on a paper medium, display on a monitor, and projection by a projector.

Returning to FIG. 4, in step S3, the template-selection button 241d or the layout-selection button 241e is activated through the input unit 23 to determine the instruction of a layout modification (Step S3). If a layout modification is not instructed through the input unit 23 (NO in Step S3), the process ends.

If a layout modification is instructed through the input unit 23 (YES in Step S3), the entry table 41 is generated (Step S4).

FIG. 8 illustrates an example entry table 41. The entry table 41 is used for entering the content of the POP improvement, i.e., the POP data of before and after a modification, to the head-office server 1. As illustrated in FIG. 8, the entry table 41 includes a header region 411, an improvement-content region 412, and a target setting region 413.

The header region 411 stores header information to clarify the details of the improvements on time, person, store, selling floor, and commercial product. Specifically, the header region 411 includes a date area 411a for storing the date of the improvement, a shop-information area 411b for storing the shop information (such as the shop name, the selling floor name, and the category), a person-in-charge-information area 411c for storing information on the persons in charge (such as the name and e-mail address of the person in charge), and a product-information area 411d for storing information on the product to be improved (target product). The header region 411 further includes an improvement-report-sheet area 411e for storing information linking an improvement report sheet 42 to the entry table 41 (file name of the improvement report sheet 42), a successful/unsuccessful-case area 411f for storing a flag representing the analytical results of the improvement (successful or unsuccessful), an analysis-sheet area 411g for storing information for linking the analytical result sheet 43, which is described below, (such as the file pass of the analytical result sheet 43), and a comment area 411h for storing an input comment.

The improvement-content region 412 stores the POP data of before and after the update. The improvement-content region 412 includes a head-office-instruction area 412a, a selling-floor-improvement area 412b, and an improvement-process area 412c. The head-office-instruction area 412a stores the POP data from the head office (POP data before modification) by each layout component. The selling-floor-improvement area 412b stores the content of the update of the POP data from the head office carried out at the selling floor (POP data after the modification). The improvement-process area 412c stores the type of process carried out on the POP data from the head office (modification, addition, or deletion).

The target setting region 413 stores a target value for sales increase to be achieved through the POP improvement. In this embodiment, a target value is set for the actual sales increase and/or the sale increase rate on a target date. The actual target sales may otherwise be set as a target value.

The target setting region 413 includes a target-date area 413a, a target-value area 413b, and an actual-value area 413c. The target-date area 413a is used to select a target date from the previous day, the next day, the previous month, and the average of a period. The target-value area 413b is used to establish the actual sales increase and/or the sale increase rate for the target date. The actual-value area 413c stores actual values representing the sales increase achieved through the POP improvement calculated on the basis of the sales data in the head-office server 1.

In Step S5 in FIG. 4, header information is allocated in the header region 411 of the entry table 41 (Step S5). Specifically, a system date is automatically allocated in the date area 411a. Shop information and information on the person in charge are read out from the person-in-charge-of-selling-area-information storage unit 254 and are automatically allocated in the shop-information area 411b and the person-in-charge-information area 411c, respectively. “Selling floor” is automatically selected for the category of the shop-information area 411b. Information on the target product is read out from the header information of the POP data and is automatically allocated in the product-information area 411d.

The POP data from the head office before the update is automatically allocated in the head-office-instruction area 412a of the entry table 41 for each layout component (Step S6).

The instruction of the update of the POP data by the input unit 23 is determined (Step S7). That is, the instruction of the update of the POP data is determined through the operation of the template list 242 or the layout editing menu 243 by the input unit 23. If the update of the POP data is instructed through the input unit 23 (YES in Step S7), the POP data is updated in accordance with the operation of the input unit 23 and stored in the improvement-POP-data storage unit 252. The content of the update is allocated in the selling-floor-improvement area 412b of the entry table 41 while the improvement process is allocated in the improvement-process area 412c (Step S8), returning the process to Step S7. Steps S7 and S8 are repeated until the update of the POP data on the template list 242 or the layout editing menu 243 is finished and the display returns to the POP menu 241.

In Step S7, upon update of the POP data (NO in Step S7), the input unit 23 determines the activation of the target setting button 241f (Step S9). If the input unit 23 activates the target setting button 241f (YES in Step S9), the entry table 41, which is illustrated in FIG. 8, is displayed on the display unit 24. Upon input of the target date and the target value respectively into the target-date area 413a and the target-value area 413b in the displayed entry table 41 from the input unit 23, the input target date and target value are established (Step S10), and the process moves on to Step S11.

If the person in charge of the selling floor wants to leave a comment, the comment can be input into the comment area 411h through the input unit 23 at this time. The default value of the category is “selling floor.” If the person in charge of the selling floor wants to select another category, a category item can be added from the input unit 23 at this time.

In Step S9, if the input unit 23 does not activate the target setting button 241f (NO in Step S9), the process moves on to Step S11.

In Step S11, the input unit 23 determines the activation of the image-acquisition button 241h (Step S11). If the input unit 23 determines the activation of the image-acquisition button 241h (YES in Step S11), the system enters an image-acquisition mode in which the image acquisition unit 27 acquires an image of the selling floor as image data (Step S12). Then, the process moves on to Step S13.

If the input unit 23 does not activate the image-acquisition button 241h (NO in Step S11), the process moves on to Step S13.

In Step S13, the input unit 23 determines the activation of the entry button 241g (Step S13). If the input unit 23 determines the activation of the entry button 241g (YES in Step S13), the input of a target value to the entry table 41 is determined (Step S14). If a target value is not input to the entry table 41 (NO in Step S14), an error message, such as “Input target value,” is displayed on the display unit 24 (Step S15), returning the process to Step S9. If a target value is input to the entry table 41 (YES in Step S14), a data file for the improvement report sheet 42 is prepared on the basis of the image data of the selling floor, the POP data before the improvement, the POP data the after improvement, and the comment area 411h of the entry table 41 (Step S16).

FIG. 9 illustrates an example format of the improvement report sheet 42. As illustrated in FIG. 9, the improvement report sheet 42 includes an image 421 of the selling floor, a POP image 422 from the head office before an improvement (update), a POP image 423 after the improvement (update), and a comment section 424.

The format of the improvement report sheet 42 can be customized through the input unit 23 and freely arranged. Graphics and characters can be added manually to the image 421 of the selling floor using painting software or other software.

The data of the improvement report sheet 42 is attached to the data of the entry table 41 to form improvement report data that is sent to the head-office server 1 via the wireless communication unit 26 (Step S17). The improvement report data is stored in the improvement-report-data storage unit 253 (Step S18), and the process ends.

If the input unit 23 does not determine the activation of the entry button 241g (NO in Step S13), the process ends.

The selling-floor terminal 2 generates a POP image based on the updated POP data in response to the activation of the output button 241i by the input unit 23 and outputs the POP image through the printer 4 or on a monitor. The updated POP image output on a paper medium or a monitor disposed on the selling floor for display contributes to the improvement of the selling floor.

Upon reception of the improvement report data from the selling-floor terminal 2 by the communication unit 16 of the head-office server 1, the received improvement report data is stored in the improvement-report-data storage unit 153.

### <Improvement Analysis>

The improvement analysis carried out by the head-office server 1 will now be described.

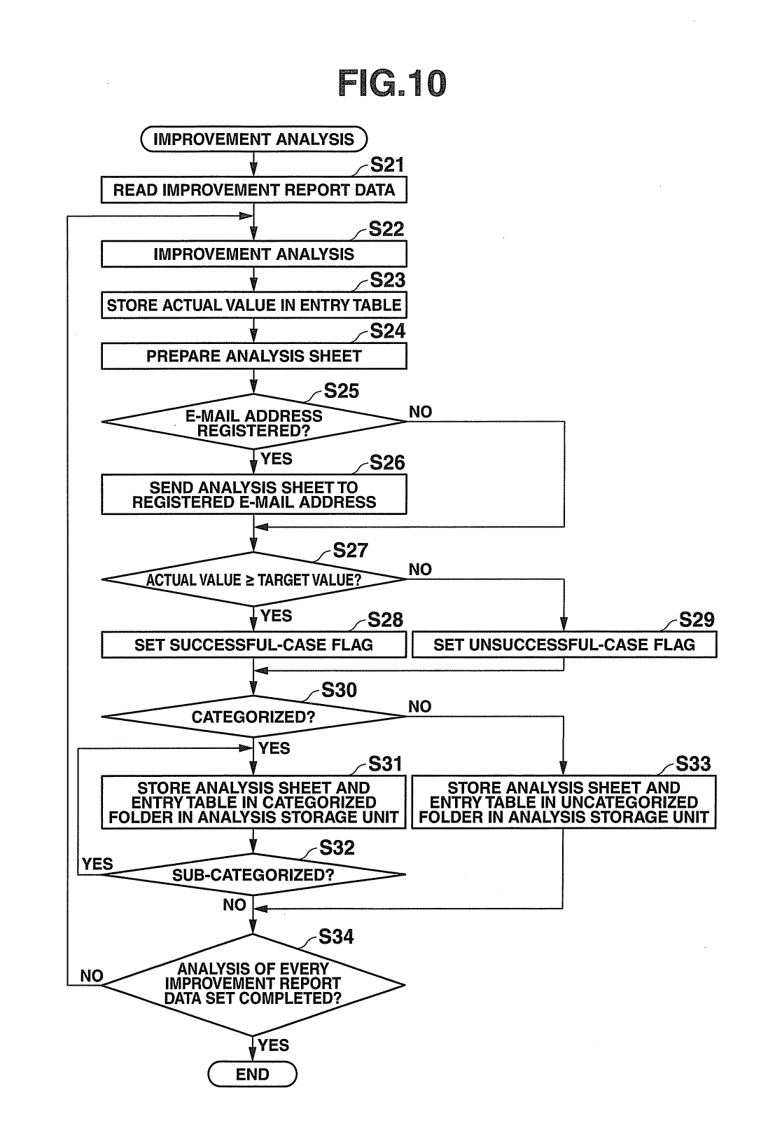

FIG. 10 is a flow chart illustrating the improvement analysis process. The improvement analysis is carried out by the CPU 11 in cooperation with the processing program 15a stored in the storage unit 15. The improvement analysis is carried out on the improvement report data of the previous business day at a predetermined time before opening the shop.

The improvement report data containing the date of the previous business day stored in the improvement-report-data storage unit 153 is extracted and loaded into the RAM 12 (Step S21). Then, the processes of Steps S22 to S33 are carried out in sequence from the beginning of the loaded improvement report data.

An improvement analysis is carried out on the improvement report data (Step S22).

Based on the sales data stored in the sales-data storage unit 152, the actual sales of the target product on the date in the date area 411a (the date on which the improvement was carried out) for a shop/selling floor established in the shop-information area 411b of the entry table 41 and the actual sales of the target product on the target date selected in the target-date area 413a are calculated. Based on the two calculated values of the actual sales, the sales increase rate (sales reduction rate) and the actual sales increase (actual sales reduction) on the target date on which the improvement was carried out are calculated as the sales effect rate and the actual sales.

The improvement analysis can be carried out using the analytical function of the POS system or the sales management system of the head-office server 1. The analysis may be carried out using Microsoft Excel or other general-purpose tools.

Upon completion of the improvement analysis, the calculated sale effect rate and actual sales are written in the actual-value area 413c of the entry table 41 (Step S23). A graph is prepared to determine the sales trend of a target product in a shop/selling floor in the shop-information area 411b of the entry table 41, and the analytical-result sheet 43 containing the POP data before and after the update, the actual sales effect, and the graph (Step S24).

FIG. 11 illustrates an example format of the analytical-result sheet 43. As illustrated in FIG. 11, the analytical-result sheet 43 includes the improvement report sheet 42 for the improvement report data, information 431 on the target product and date of the improvement, the actual sales 432, and a sales trend graph 433. That is, the analytical-result sheet 43 includes the POP data before and after the update and the analytical results on the sales effect achieved through POP improvement.

The format of the analytical-result sheet 43 is not limited to that described above and may be modified to any format that includes the POP data before and after the update and the analytical results on the sales increased achieved through the POP improvement.

The input of an e-mail address to the person-in-charge-information area 411c of the entry table 41 of the improvement report data is determined (Step S25). If an e-mail address is input (YES in Step S25), the analytical-result sheet 43 is sent to the e-mail address via the communication unit 16 (Step S26). Then, the process moves on to Step S27. If the e-mail address is not input to the person-in-charge-information area 411c (NO in Step S25), the process moves on to Step S27.

The analytical results of the sales increase achieved through the POP improvement is sent to the person in charge of the selling floor in which the POP improvement was carried out so that the person in charge can use the analytical results for future improvements. Reception of such analytical results will motivate the person in charge.

In Step S27, the actual sales calculated in the improvement analysis is determined to be larger than or equal to the target value in the target-value area 413b of the entry table 41 of the improvement report data (Step S27).

If the calculated actual sales is larger than or equal to the target value (YES in Step S27), a successful-case flag is established in the successful/unsuccessful-case area 411f of the entry table 41 (Step S28). Then, the process moves on to Step S30. If the calculated actual sales is smaller than the target value (NO in Step S27), an unsuccessful-case flag is established in the successful/unsuccessful-case area 411f of the entry table 41 (Step S29). Then, the process moves on to Step S30.

In Step S30, the presence of a folder of the category established in the shop-information area 411b of the entry table 41 in the analytical-result storage unit 154 is determined (Step S30). If the category input to the shop-information area 411b is stored in the analytical-result storage unit 154 (YES in Step S30), the entry table 41 and the analytical-result sheet 43 are linked and stored together in the folder of the relevant category in the analytical-result storage unit 154 (Step S31). If the next category is input to the shop-information area 411b of the entry table 41 (YES in Step S32), the process returns to Step S31. If the next category is not input to the shop-information area 411b of the entry table 41 (NO in Step S32), the process moves on to Step S34.

Alternatively, if the folder of the category input to the shop-information area 411b of the entry table 41 is not present (NO in Step S30), the entry table 41 and the analytical-result sheet 43 are linked and stored in an uncategorized folder in the analytical-result storage unit 154 (Step S33). Then, the process moves on to Step S34.

The entry table 41 and the analytical-result sheet 43 are linked by storing the destination (file pass) of the file of the analytical-result sheet 43 in the analytical-result-sheet area 411g of the entry table 41.

In Step S34, the processes of Steps S22 to S33 carried out on all sets of the improvement report data loaded into the RAM 12 is determined (Step S34). If all sets of the improvement report data are not processed in accordance with Steps S22 to S33 (NO in Step S34), the process returns to Step S22 to process the next set of the improvement report data in accordance with Steps S22 to S33. If all sets of the improvement report data are processed in accordance with Steps S22 to S33 (YES in Step S34), the process ends.

### <Success-Case Browsing>

The success-case browsing process will now be described. Successful cases stored in the analytical-result storage unit 154 of the head-office server 1 can be browsed from the selling-floor terminal 2.

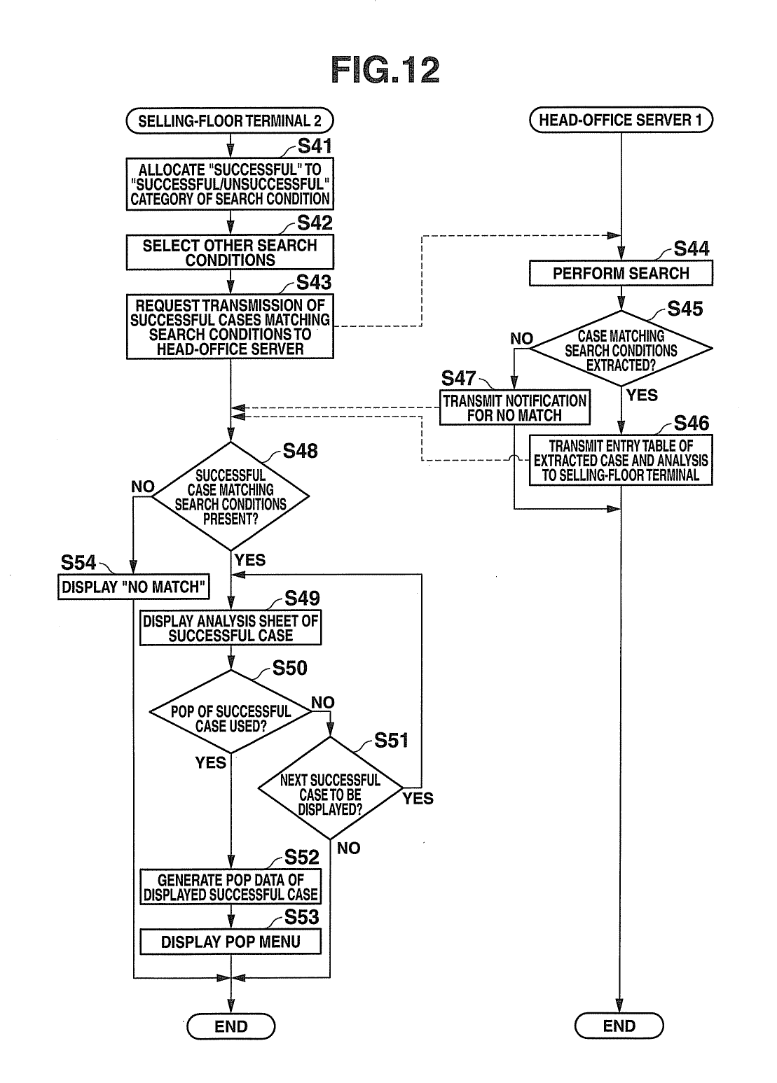

FIG. 12 is a flow chart illustrating the successful-case browsing process. The successful-case browsing at the selling-floor terminal 2 is carried out by the CPU 21 in cooperation with the processing program 25a stored in the storage unit 25. The successful-case browsing at the head-office server 1 is carried out by the CPU 11 in cooperation with the processing program 15a stored in the storage unit 15.

A search menu (not shown) is displayed on the display unit 24 of the selling-floor terminal 2, and the input unit 23 selects “successful” for the search condition “successful/unsuccessful” (Step S41).

Then, upon selection of other search conditions (including the category) and activation of the transmission button by the input unit 23 (Step S42), the wireless communication unit 26 requests the transmission of a successful case that matches the selected search conditions to the head-office server 1 (Step S43).

The search conditions may include the category and the items in the entry table 41, such as the product, the selling floor, the POP improvement (layout), the target sales effect rate, and the actual sales increase. For example, the successful case of a POP of a specific sheet size for a specific product on sale on a specific selling floor can be retrieved by selecting the search conditions of the product, the selling floor, and POP sheet size. For example, the successful case of a POP of a specific template type can be retrieved by selecting the search condition of the type of the POP template. For example, the successful case of a POP having the price displayed in a specific format (size, color, and type of font (such as Ming-style typeface, handwriting font, or Gothic typeface)) can be retrieved by setting the search condition of a specific format of the price.

The person in charge of the selling floor can retrieve successful cases from the head-office server 1 by different components of the POP layout (for example, different sheet sizes, different template types, and different fonts) for the selling floor and products he/she is in charge of. In this way, he/she can prepare POPs that enhance sales of products on the selling floor he/she is in charge of.

The input unit 23 may be used for selecting search conditions and determining the output order for browsing of the successful cases matching the search conditions. For example, efficient browsing of the successful cases is achieved by settling the output order by, for example, a descending order of sales effect rate or actual sales increase, by selling floors, by the persons in charge of the selling floors, or by shops.

Upon reception of the transmission request of successful cases matching the search conditions from the selling-floor terminal 2 to the head-office server 1 via the communication unit 16, the analytical-result storage unit 154 searches for data on the cases matching the received search conditions (Step S44). Specifically, the information in the entry tables 41 stored in the analytical-result storage unit 154 is searched to extract the entry tables 41 that match the search conditions and the files of the analytical result sheets 43 corresponding to the extracted entry tables 41.

Upon completion of the search, the head-office server 1 determines the extraction of data on the cases matching the search conditions (the entry tables 41 and the analytical result sheets 43) (Step S45). If the data of the cases matching the search conditions is extracted (YES in Step S45), the extracted data, i.e., the entry tables 41 and the analytical result sheets 43 are transmitted to the selling-floor terminal 2 that is the requestor via the communication unit 16 (Step S46). If the order of output from the selling-floor terminal 2 is selected, the entry tables 41 and the analytical result sheets 43 are sorted by the selected output order and are transmitted to the selling-floor terminal 2 that is the requestor via the communication unit 16.

If data of the cases matching the search conditions is not extracted (NO in Step S45), a notification of no corresponding successful cases is sent to the selling-floor terminal 2 via the communication unit 16 (Step S47).

Upon reception of a response from the head-office server 1 by the wireless communication unit 26 of the selling-floor terminal 2, the selling-floor terminal 2 determines the reception of the successful cases matching the search conditions (Step S48). If the successful cases matching the search conditions are not received (NO in Step S48), a notification of this appears on the display unit 24 (Step S54), and the process ends.

If the successful cases matching the search conditions are received (YES in Step S48), one of the analytical result sheets 43 of the successful cases appears on the display unit 24 (Step S49). A use button to be activated to use the POP of displayed successful case also appears on the display unit 24. The input unit 23 may sends instructions to the selling-floor terminal 2 to transmit the data on the analytical result sheet 43 to the printer 4 for print out on a sheet or to store the data in the storage unit 25 in a specific file format.

The input unit 23 determines the instruction to use the POP of the successful case displayed on the display unit 24 (Step S50). If the instruction to use the POP of the successful case is not received and the display of the next successful case is instructed (NO in Step S50 and YES in Step S51), the process returns to Step S49, and the analytical result sheet 43 of the next successful case appears on the display unit 24.

If the input unit 23 determines the instruction to use the POP of the successful case (YES in Step S50), the information on the layout of the improved POP is acquired from the improvement-content region 412 of the entry table 41 corresponding to the analytical result sheet 43 displayed on the display unit 24, and the corresponding POP data is generated (Step S52). Subsequently, the POP preparation program is launched to generate a POP image based on the generated POP data, and the POP menu 241 containing the generated POP image in the POP display area 241a is displayed on the display unit 24 (Step S53), ending the process. The POP image displayed in the POP menu 241 can be output or further modified before output. That is, the POP of a successful case can be used.

In Step S51, if the display of the next successful case is not instructed, i.e., if the input unit 23 has instructed not to display the next successful case or if no subsequent successful case is found (NO in Step S51), the process ends.

The generation of POP data of a successful case by the selling-floor terminal 2 has been described with reference to FIG. 12. Alternatively, the head-office server 1 may include a unit for generating the POP data of a successful case, and the generated POP data may be transmitted to the selling-floor terminal 2. That is, the POP data may be generated by acquiring information on the layout of the improved POP from the improvement-content region 412 of the entry table 41 extracted in Step S45 and may be transmitted to the selling-floor terminal 2 together with the entry table 41 and the analytical result sheet 43.

As described above, in response to update of the POP data, the CPU 21 of every selling-floor terminal 2 in the selling-floor improvement system 100 acquires the POP data of before and after the update and transmits improvement report data to the head-office server 1 via the wireless communication unit 26, in which the improvement report data consists of the POP data of before and after the update linked together with the information on the product in the POP, and the date, shop, selling floor, and person in charge of the selling floor concerning the updated POP data. The CPU 11 of the head-office server 1 analyzes the effect of the updated POP data recorded in the improvement report data received by the communication unit 16 on the sales of the target product on the selling floor in the shop, links the analytical results to the improvement report data, and stores the linked data in the storage unit 15. In response to a request from the selling-floor terminal 2, the CPU 11 sends the improvement report data stored in the storage unit 15 corresponding to at least the POP data of before and after the update and the corresponding analytical results via the communication unit 16.

The POP improvement can be readily registered in the head-office server 1 without requiring input by the person in charge of the selling floor, and the sales effect of the POP improvement can be confirmed by the person in charge. This motivates and encourages the person in charge to make active improvements that lead to a sales increase.

Data on the sales effect by the POP improvement carried out by the person in charge of the selling floor is analyzed and accumulated in the head-office server 1. This allows the head office to collect reliable information on the improvements carried out on the individual selling floors and to readily recognize effective and ineffective improvements for further improvements to be carried out on the selling floors. Such data can be used as a reference when the head office instructs the shops to prepare the POPs.

The POP improvements on the selling floors and the effect of the improvements on the sales can be browsed using the selling-floor terminals 2. This enables efficient improvements on the selling floors by adopting the highly effective improvements. The synergetic effect of all the shops leads to a further sales increase.

Successful-case flags are added to the improvement reports satisfying a predetermined criterion and the analytical results of the improvement reports before storing them in the storage unit 15. In this way, successful cases that are useful for improvement of other shops can be readily retrieved.

The selling-floor terminal 2 can acquire the successful cases that match the desired search conditions, such as the content of the improvement and the category. This enables analysis and determination of POPs that are effective for sales increase on the selling floors.

The head-office server 1 or the selling-floor terminal 2 can generate the improved (updated) POP data on the basis of the content of the improvement (update of POP) in the entry table 41. In this way, the POP data of POPs prepared in other shops can be loaded in the selling-floor terminal 2 of another shop and used on the selling floor.

If the improvement report data contains information on the destination of the analytical results, such as an e-mail address of the person in charge of a selling floor, the analytical results of the POP improvement is transmitted to the destination. Thus, the person in charge of the selling floor on which POP improvement has been carried out can confirm the effect of the improvement on sales by e-mail and is not required to access the head-office server 1.

Although preferred embodiments of the selling-floor improvement system 100 according to the present invention are described above, the present invention can include any modification.

For example, in the embodiment described above, the items of the entry table 41, such as the header information and the content of the improvements, are automatically allotted. Alternatively, the person in charge of the selling floor may input such information from the input unit 23. In such a case, the items in the entry table 41 can be added as desired.

For example, in the embodiment described above, a case is categorized as “successful” if the actual sales or the sales effect rate exceeds a target value. Alternatively, any other criterion for the determination of “successful” or “unsuccessful” can be employed without limitation at the head-office server 1.

In this embodiment, the POP data from the head-office server 1 is improved on the selling floor; however, the POP data to be improved is not limited to that from the head-office server 1. For example, the POP data entered by the person in charge of the selling floor may be further improved. In addition, improvements may be carried out on the POP data of successful and unsuccessful cases in other shops.

In the embodiment described above, the analytical result sheet 43 is sent to the e-mail address of the person in charge that has been entered in advance. Alternatively, the analytical result sheet 43 may be sent to multiple e-mail addresses in the entry table 41, such as the e-mail address of the supervisor. Instead of sending the analytical results to the e-mail address of the person in charge that has been entered in advance, the analytical result sheet 43 may be transmitted to a selling-floor terminal 2 selected in advance.

In the embodiment described above, the selling-floor terminals 2 browse the successful cases. The selling-floor terminals 2 may also browse unsuccessful cases by selecting “unsuccessful” in the “successful/unsuccessful case” category.

In the embodiment described above, the head-office server 1 includes one device. Alternatively, the head-office server 1 may include a group of servers.

For example, the sales effect analysis carried out by the head-office server 1 according to the embodiment described above may be carried out by a separate POS system or another sales management system.

In the embodiment described above, the head-office server 1 at the head office that is comprehensively controlling the shops receives input from the selling-floor terminals 2 and functions as a server for storage and management of data on the analytical results of the POP improvements (entry tables 41 and analytical result sheets 43). The head-office server 1, however, may have any other function. For example, a server of a specific shop or a terminal (backyard terminal) of a specific shop office may have the functions of the server described above to store and manage the analytical results of the POP improvements. Such data may otherwise be managed by a management system that has the functions described above in cloud storage.

In the embodiment described above, the sales data of the shops are stored in the head-office server 1; alternatively, the sales data may be collected from the servers or the backyard terminals of the shops while performing improvement analysis.

In the embodiment described above, the selling-floor terminal 2 is used for input of the POP improvements and other items and browsing of the successful cases, while the head-office server 1 is used for storage and management of the analysis of the sales effect of the POP improvements and the successful cases. Alternatively, backyard terminals, which have the functions of both the head-office server 1 and the selling-floor terminal 2, may be installed in the shop offices such that a single backyard terminal is used for the input of the POP improvements, input of various items, the analysis of the sales effect, and the storage, management, and browsing of the successful cases. A preferable example of the selling-floor terminal 2 described above is a portable terminal. Alternatively, a fixed terminal may be used.

The detailed configurations and operations of the components of the selling-floor improvement system 100 may be modified appropriately without departing from the scope of the invention.

The entire disclosure of Japanese Patent Application NO. 2012-064057 filed on Mar. 21, 2012 including description, claims, drawings and abstract are incorporated herein by reference in its entirety.

What is claimed is:

1. A data processing system, comprising:
a plurality of terminals; and
a server connected to the terminals via a communication network,
wherein each of the terminals includes:
a display unit which displays a POP advertisement based on predetermined layout data of the POP advertisement,
a layout modifier which modifies the layout data of the POP advertisement displayed on the display unit in response to a user operation; and
an improvement-report-data transmitter which acquires the layout data of the POP advertisement of before and after a modification by the layout modifier, generates improvement report data by linking the acquired layout data with information on a target product in the POP advertisement and information associated with the modification of the layout data of the POP advertisement, and transmits the improvement report data to the server, and
wherein the server includes:
an improvement analyzer which analyzes a sales effect of the target product on the selling floor of the shop in which the modification was carried out on the layout data of the POP advertisement reported in the improvement report data from any of the terminals, links the analytical result with the improvement report data, and stores the linked analytical result and the improvement report data in a storage unit; and
an analysis transmitter which transmits at least the POP advertisement of before and after the modification and the analytical result of the modification among the improvement report data stored in the storage unit in response to a request from any one of the terminals.

2. The data processing system according to claim 1, wherein
the improvement analyzer determines the fulfillment of a predetermined criterion of the sales effect of the target product on the selling floor of the shop in which the modification was carried out on the layout data of the POP advertisement and, if the criterion is fulfilled, links a successful-case flag to the improvement report data, and stores the improvement report data in the storage unit, and
the analysis transmitter, in response to a request from any one of the terminals, transmits at least the POP advertisement of before and after the modification and the analytical result of the modification among the improvement report data stored in the storage unit and linked to the successful-case flag to the terminal from which the request is transmitted.

3. The data processing system according to claim 1, wherein each of the terminals further includes:
a search-condition selector which selects a search condition; and
a transmitter which transmits a transmission request of the modification of the POP advertisement matching the search condition selected by the search-condition selector and an analytical result of the modification to the server,
wherein the analysis transmitter extracts the improvement report data matching the search condition transmitted from any one of the terminals and the analytical result corresponding to the improvement report data from the storage unit and transmits at least the POP advertisement of before and after the modification and the analytical result of the modification among the extracted improvement report data to the terminal from which the request is transmitted.

4. The data processing system according to claim 1, wherein each of the terminals further includes a layout-data generator which generates layout data for a modified POP advertisement on the basis of the POP advertisement of before and after the modification transmitted from the server.

5. The data processing system according to claim 1, wherein the server further includes a layout-data generator which generates layout data for a modified POP advertisement on the basis of the POP advertisement of before and after the modification and transmits the generated layout data to one of the terminals from which the request is transmitted.

6. The data processing system according to claim 1, wherein
the improvement report data includes information on a destination of the analytical result, and
the improvement analyzer transmits the analytical result to a destination specified in the improvement report data.

7. A server connected to a terminal via a communication network, the server comprising:
a receiver which receives improvement report data including a modification performed on predetermined layout data of a POP advertisement transmitted from the terminal, information on a target product in the POP advertisement and information associated with the modification of the layout data of the POP advertisement;
an analyzer which analyzes a sales effect on the target product on the selling floor of the shop in which the modification was carried out on the layout data of the POP advertisement reported in the improvement report data from any of the terminals, links the analytical result with the improvement report data, and stores the linked analytical result and the improvement report data in a storage unit; and
a transmitter which transmits at least the POP advertisement of before and after the modification and the analytical result of the modification among the improvement report data stored in the storage unit in response to a request from the terminal.

8. A non-transitory computer-readable medium which stores a program for instructing a computer to perform a procedure, the procedure comprising:
receiving improvement report data containing a modification performed on predetermined layout data of a POP advertisement, information on a target product in the POP advertisement and information associated with the modification of the layout data of the POP advertisement from a terminal connected via a communication network;
analyzing a sales effect of the target product on the selling floor of the shop in which the modification was carried out on the layout data of the POP advertisement reported in the improvement report data from the terminals, linking the analytical result with the improvement report data, and storing the linked analytical result and the improvement report data in a storage unit; and
transmitting at least the POP advertisement of before and after the modification and the analytical result of the modification among the improvement report data stored in the storage unit in response to a request from the terminal.
